(19) United States
(12) Patent Application Publication
(10) Pub. No.: US 2016/0097482 A1
(43) Pub. Date: Apr. 7, 2016

(54) GENERATOR STAND

(71) Applicants: Bonnie Ann KAMHI, Asbury Park, NJ (US); Paul Louis Vehling, Long Branch, NJ (US)

(72) Inventors: Bonnie Ann KAMHI, Asbury Park, NJ (US); Paul Louis Vehling, Long Branch, NJ (US)

(21) Appl. No.: 14/505,232

(22) Filed: Oct. 2, 2014

(51) Int. Cl. F16M 5/00; F16M 7/00

(52) U.S. Cl. CPC F16M 5/00; F16M 7/00

(57) ABSTRACT

A generator stand is provided. The generator stand includes a plurality of vertical posts each having a bottom end and a top end. The present invention may further include at least one lower horizontal post connecting at least a first vertical post and a second vertical post in between the bottom end and the top end. The present invention may further include a top frame attaching the top end of the plurality of vertical posts. The top frame may include a support frame sized to support a generator. A gap is formed in between the top frame and the at least one lower horizontal post. A portion between the bottom end and the at least one lower horizontal post of each of the plurality of vertical posts is buried within a surface.

### BACKGROUND OF THE INVENTION

The present invention relates to a generator support stand and, more particularly, to a generator support stand that supports the generator above the ground.

An engine-generator is the combination of an electrical generator and an engine mounted together to form a single piece of equipment. This combination is also called an engine-generator set or a gen-set. Currently, home or business generators may be placed outdoors on concrete pads. However, generators that are mounted on concrete pads have issues when there is excess rain or snow of more than 2-3 inches. For example, on properties that are prone to flooding, it is beneficial that the generator be raised a minimum of about 2 feet above ground. Since generators are currently not raised high enough, rain and snow may cause damage to generator. Further, the owner of the generator may have to clear the snow around the generator.

As can be seen, there is a need for a frame that supports the generator above the ground.

### SUMMARY OF THE INVENTION

In one aspect of the present invention, a generator stand comprises: a plurality of vertical posts each comprising a bottom end and a top end; at least one lower horizontal post connecting at least a first vertical post and a second vertical post in between the bottom end and the top end; a top frame attaching the top ends of the plurality of vertical posts and comprising a support frame sized to support a generator, wherein a gap is formed in between the top frame and the at least one lower horizontal post, wherein a portion between the bottom end and the at least one lower horizontal post of each of the plurality of vertical posts is buried within a surface.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention shown in exemplary usage;

FIG. 2 is a perspective view of the present invention;

FIG. 3 is a front view of the present invention;

FIG. 4 is a side view of the present invention;

FIG. 5 is a top view of the present invention;

FIG. 6 is an exploded view of the present invention;

FIG. 7 is a section detail view of the present invention along line 7-7 in FIG. 1; and

FIG. 8 is a section detail view of the present invention along line 8-8 in FIG. 5.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a generator stand for outdoor purposes. In certain embodiments, the present invention may include a top frame where the generator is secured. The generator may be positioned about two feet above ground or higher. Further, the stand may be embedded around three feet under the ground for additional support or in compliance with code of a municipality. Four holes that are three feet deep may be made and the legs of the stand may be placed in the holes. Concrete may then be poured into the holes. Since the generator may be about two feet above ground, air, rain and snow can pass underneath the generator, thereby preventing damage. The generator stand described below may be made of steel and the components may be welded together.

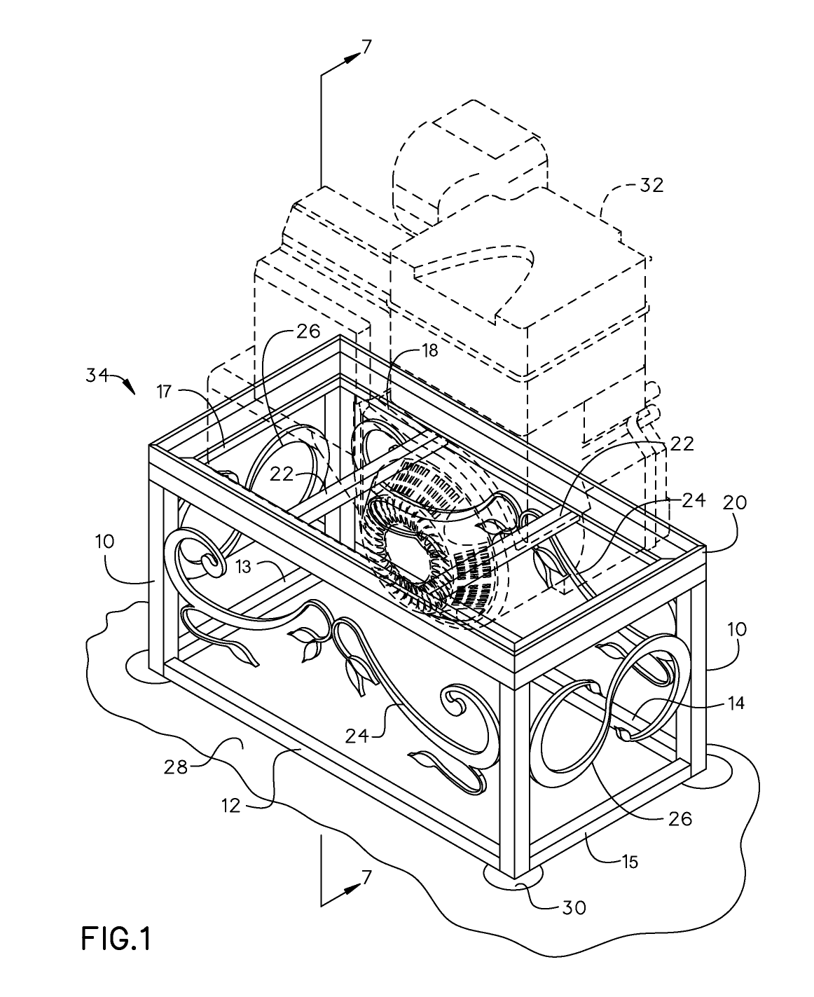

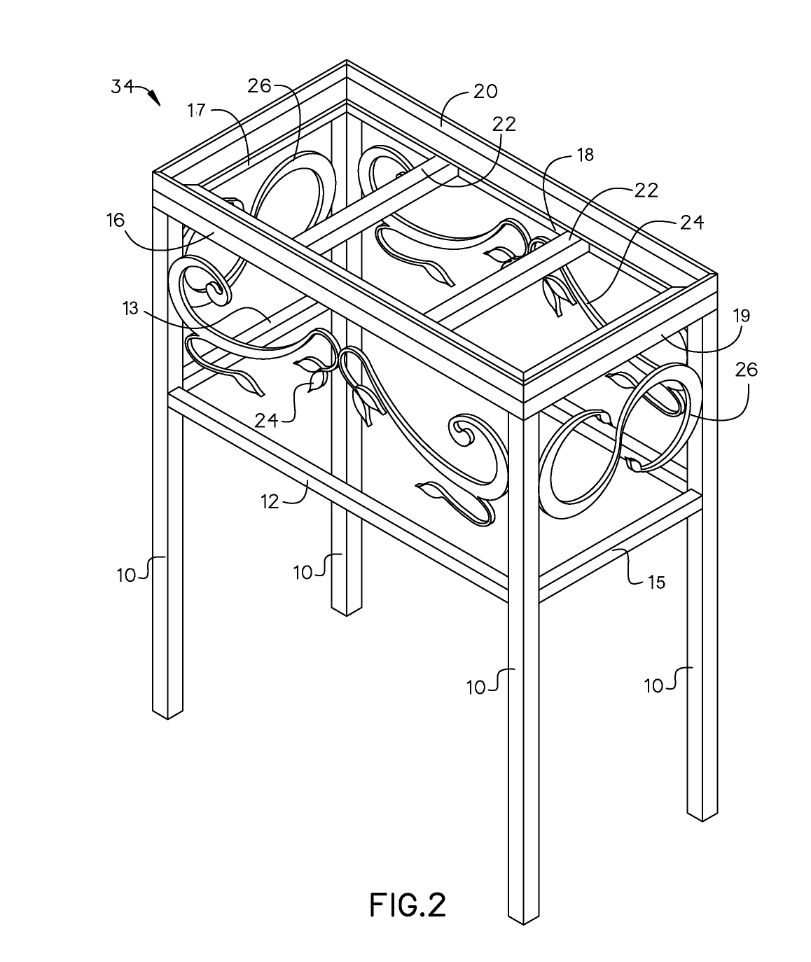

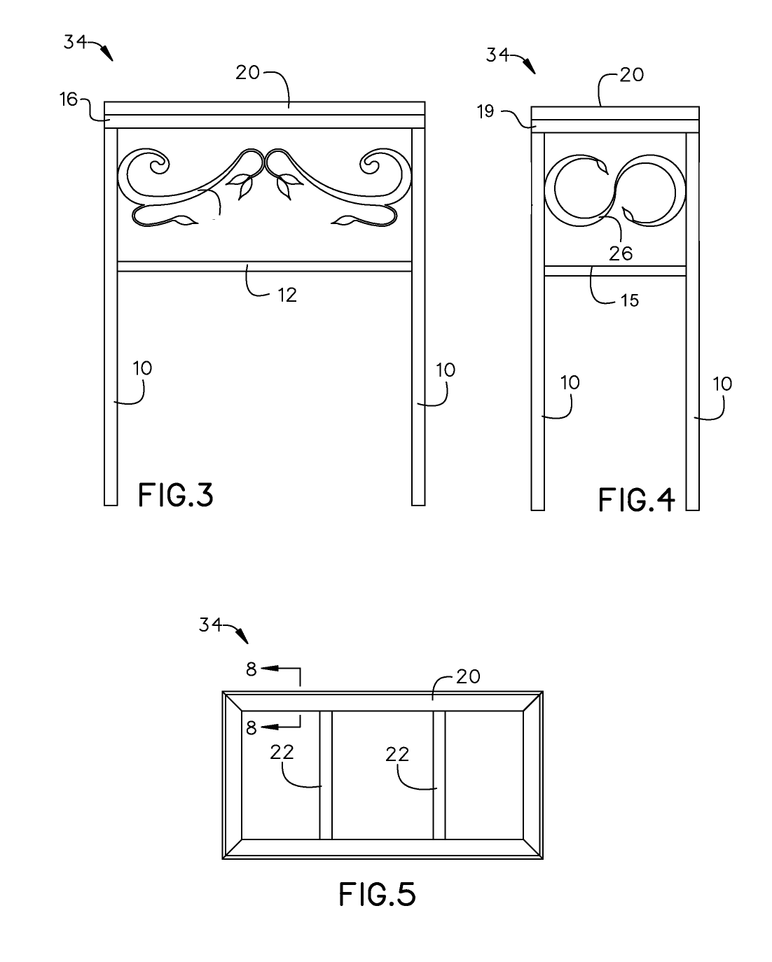

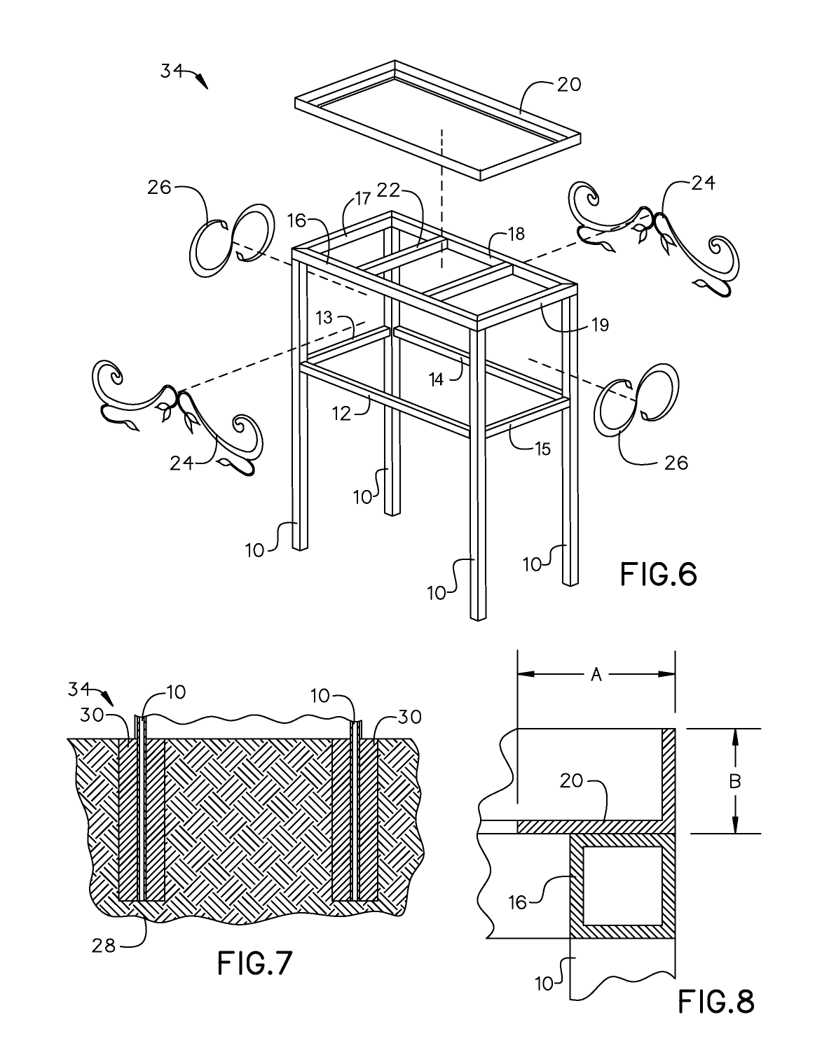

Referring to FIGS. 1 through 8, the present invention includes a generator stand 34. The generator stand 34 includes a plurality of vertical posts 10 each having a bottom end and a top end. The present invention may further include at least one lower horizontal post 12 connecting at least a first vertical post 10 and a second vertical post 10 in between the bottom end and the top end. The present invention may further include a top frame attaching the top end of the plurality of vertical posts 10. The top frame may include a support frame 20 sized to support a generator 32. A gap is formed in between the top frame and the at least one lower horizontal post 12. A portion between the bottom end and the at least one lower horizontal post 12 of each of the plurality of vertical posts 10 is buried within a surface 28.

In certain embodiments, the plurality of vertical posts 10 may include four vertical posts 10 including the first vertical post 10, the second vertical post 10, a third vertical post 10, and a fourth vertical post 10. In certain embodiments, the vertical posts 10 may be two inch square tube support beams with a thickness of one quarter of an inch. However, the vertical posts 10 are not limited to such, and may be any appropriate size. In certain embodiments, the surface 28 may include four holes. The four vertical posts 10 may be within the four holes. Concrete 30 may be placed within the holes, thereby securing the four vertical posts 10 to the surface 28.

In certain embodiments, the at least one lower horizontal post 12 may include four lower horizontal posts 12, 13, 14, 15, such as a first lower horizontal post 12, a second lower horizontal post 13, a third lower horizontal post 14, and a fourth lower horizontal post 15. The lower horizontal posts 12, 13, 14, 15 may be about one and a half inch square tube cross beams, with a thickness of one quarter of an inch. However, the lower horizontal posts 12, 13, 14, 15 are not limited to such, and may be any appropriate size. In certain embodiments, the first lower horizontal post 12 connects the first vertical post 10 and the second vertical post 10, the second lower horizontal post 13 connects the second vertical post 10 and the third vertical post 10, the third lower horizontal post 14 connects the third vertical post 10 and the fourth vertical post 10, and the fourth lower horizontal post 15 connects the fourth vertical post 10 and the first vertical post 10.

As mentioned above, a gap may be formed in between the horizontal posts 12, 13, 14, 15 and the top frame. Therefore, the elements may pass underneath the generator 32 and through the gap. In certain embodiments, the present invention may further include a decorative piece 24. The decorative piece 24 may be attached to the generator stand 34 and may at fill at least a portion of the gap. In certain embodiments, the present invention may include front and back decorative pieces 24, and side decorative pieces 26. The decorative pieces 24, 26 may be a steel forged design.

The top frame of the present invention may include four upper horizontal posts 16, 17, 18, 19 such as a first upper horizontal post 16, a second upper horizontal post 17, a third upper horizontal post 18, and a fourth upper horizontal post 18. The upper horizontal posts 16, 17, 18, 19 may be about two inch square tube cross beams. However, the horizontal posts 12, 13, 14, 15 are not limited to such, and may be any appropriate size. In certain embodiments, the first upper horizontal post 16 connects the first vertical post 10 and the second vertical post 10, the second upper horizontal post 17 connects the second vertical post 10 and the third vertical post 10, the third upper horizontal post 18 connects the third vertical post 10 and the fourth vertical post 10, and the fourth upper horizontal post 19 connects the fourth vertical post 10 and the first vertical post 10.

In certain embodiments, the top frame may further include at least one cross beam 22. As illustrated in the Figures, the present invention may include two cross beams 22. The cross beams 22 may be about two inch square tube cross beams. However, the cross beams 22 are not limited to such, and may be any appropriate size. The cross beams 22 may connect the first upper horizontal post 16 and the third upper horizontal post 18. The cross beams 22 may also connect the second upper horizontal post 17 and the fourth upper horizontal post 19. The cross beams 22 may be used to further support a heavy generator 32.

The support frame 20 of the present invention may either be integrated with the top frame or the support frame 20 may be a separate piece. The support frame may be about two inch by three inch L-shaped top frame with the two inch top flange facing upward. However, the support frame 20 is not limited to such, and may be any appropriate size. The top flange of the support frame 20 may extend upward from an outer perimeter of the support frame 20. The generator 34 is secured within the top flange.

It should be understood, of course, that the foregoing relates to exemplary embodiments of the invention and that modifications may be made without departing from the spirit and scope of the invention as set forth in the following claims.

What is claimed is:

1. A generator stand comprising:
a plurality of vertical posts each comprising a bottom end and a top end;
at least one lower horizontal post connecting at least a first vertical post and a second vertical post in between the bottom end and the top end;
a top frame attaching the top ends of the plurality of vertical posts and comprising a support frame, wherein a gap is formed in between the top frame and the at least one lower horizontal post; and
a generator secured to the support frame,
wherein a portion between the bottom end and the at least one lower horizontal post of each of the plurality of vertical posts is buried within a ground so that the gap is in between the generator and the ground.

2. The generator stand of claim 1, wherein the plurality of vertical posts comprises four vertical posts comprising the first vertical post, the second vertical post, a third vertical post, and a fourth vertical post.

3. The generator stand of claim 2, wherein the ground comprises four holes, wherein the four vertical posts are within the four holes.

4. The generator stand of claim 3, wherein concrete is within the four holes, thereby securing the four vertical posts to the ground.

5. The generator stand of claim 2, wherein the at least one lower horizontal post comprises four lower horizontal posts comprising a first lower horizontal post, a second lower horizontal post, a third lower horizontal post, and a fourth lower horizontal post, wherein the first lower horizontal post connects the first vertical post and the second vertical post, the second lower horizontal post connects the second vertical post and the third vertical post, the third lower horizontal post connects the third vertical post and the fourth vertical post, and the fourth lower horizontal post connects the fourth vertical post and the first vertical post.

6. The generator stand of claim 1, further comprising at least one decorative piece attached to the generator stand, wherein the at least one decorative piece fills at least a portion of the gap.

7. The generator stand of claim 1, wherein the top frame comprises four upper horizontal posts comprising a first upper horizontal post, a second upper horizontal post, a third upper horizontal post, and a fourth upper horizontal post, wherein the first upper horizontal post connects the first vertical post and the second vertical post, the second upper horizontal post connects the second vertical post and the third vertical post, the third upper horizontal post connects the third vertical post and the fourth vertical post, and the fourth upper horizontal post connects the fourth vertical post and the first vertical post.

8. The generator stand of claim 7, wherein the top frame further comprises at least one cross beam connecting the first upper horizontal post and the third upper horizontal post.

9. The generator stand of claim 8, wherein the at least one cross beam is two cross beams.

10. The generator stand of claim 1, wherein the support frame comprises an L-shape.

11. The generator stand of claim 11, wherein a top flange extends upward from an outer perimeter of the support frame, wherein the generator is secured within the top flange.
